(19) United States
(12) Patent Application Publication
(10) Pub. No.: US 2023/0264343 A1
(43) Pub. Date: Aug. 24, 2023

(54) Wearable Robot

(71) Applicants: Hyundai Motor Company, Seoul (KR); Kia Corporation, Seoul (KR)

(72) Inventors: Beom Su Kim, Yongin-si (KR); Ju Young Yoon, Suwon-si (KR); Seong Taek Hwang, Suwon-si (KR); Sang In Park, Suwon-si (KR); Min Woong Jeung, Seoul (KR)

(21) Appl. No.: 17/891,393

(22) Filed: Aug. 19, 2022

(30) Foreign Application Priority Data
Feb. 21, 2022 (KR) 10-2022-0022514

(51) Int. Cl. B25J 9/00

(52) U.S. Cl. CPC B25J 9/0006

(57) ABSTRACT

An embodiment wearable robot includes a rear body unit configured to be provided in close contact with a rear side of a user, the rear body unit including a first link, and a link module having a first side coupled to the rear body unit and a second side configured to be positioned on a shoulder of the user, the link module including a second link rotatably coupled to a first side of the first link, a third link rotatably coupled to a second side of the first link, and a fourth link having a first side rotatably coupled to the second link and a second side rotatably coupled to the third link, the fourth link being configured to extend to the shoulder of the user.

### CROSS-REFERENCE TO RELATED APPLICATIONS

This application claims the benefit of Korean Patent Application No. 10-2022-0022514, filed on Feb. 21, 2022, which application is hereby incorporated herein by reference.

### TECHNICAL FIELD

Exemplary embodiments relate to a wearable robot.

### BACKGROUND

In the case of exoskeleton (Exo) robots worn on the body of a person, the Exo-robot assists with force required for the movement of the person and thus serves to reduce force required for daily life or a work activity of the person. For example, in the case of Exo-robots worn on the upper body of a person, the Exo-robot serves to assist with force required for the movement of the upper body of the person, such as the rotational movement of the shoulder joint or the rotational movement of the elbow joint.

Also, the movements of the joints provided in the upper body of the person include the movement of the sternoclavicular joint in addition to the movements of the shoulder joint and elbow joint of the person. The clavicle rotates about the sternoclavicular joint described above, and in this case, protraction motion and retraction motion occur in the shoulder of the person.

However, in the case of Exo-robots worn on the upper bodies according to the related art, when a person performs the protraction motion and retraction motion by rotating the clavicle about the sternoclavicular joint, the shape of the robot may not change in response to such movements. Consequently, not only are the protraction motion and retraction motion of the person restricted, but also wearing comfort of the Exo-robot is significantly deteriorated.

### SUMMARY

Exemplary embodiments relate to a wearable robot. Particular embodiments relate to a wearable robot capable of being worn on the upper body of a user.

Exemplary embodiments of the present invention provide an Exo-robot having a structure in which the shape thereof may change in response to protraction motion and retraction motion of a person.

An exemplary embodiment of the present invention provides a wearable robot including a rear body unit provided in close contact with the rear of the user and a link module, of which one side is coupled to the rear body unit and the other side is positioned on the shoulder of the user, wherein the rear body unit includes a first link, and the link module includes a second link rotatably coupled to one side of the first link, a third link rotatably coupled to one side of the first link, and a fourth link, of which one side is rotatably coupled to the second link and another side is rotatably coupled to the third link, and which extends to the shoulder of the user.

A direction in which the second link extends may be parallel to a direction in which the third link extends.

The third link may be located behind the second link.

The second link may include a second-first link region, of which one side is rotatably coupled to the first link and which extends to the outside in a left-right direction, and a second-second link region which extends from the left-right direction outer end of the second-first link region to the outside in the left-right direction, wherein the second-second link region extends to be inclined upward.

The second link may further include a second-third link region which extends from the left-right direction outer end of the second-second link region to the outside in the left-right direction, wherein the fourth link is rotatably coupled to the second-third link region.

The third link may include a third-first link region, of which one side is rotatably coupled to the first link and which extends to the outside in a left-right direction, and a third-second link region which extends from the left-right direction outer end of the third-first link region to the outside in the left-right direction, wherein the third-second link region extends to be inclined upward.

The third link may further include a third-third link region which extends from the left-right direction outer end of the third-second link region to the outside in the left-right direction, wherein the fourth link is rotatably coupled to the third-third link region.

A virtual line extending from a region in which the first link is coupled to the second link and a region in which the first link is coupled to the third link may be parallel to a virtual line extending from a region in which the second link is coupled to the fourth link and a region in which the third link is coupled to the fourth link.

The link module may include a right link module, of which one side is coupled to the first link and the other side is positioned on the right shoulder of the user, and a left link module, of which one side is coupled to the first link and the other side is positioned on the left shoulder of the user, wherein a region in which the second link of the right link module is coupled to the first link is located on the left of a region in which the second link of the left link module is coupled to the first link.

A region in which the third link of the right link module is coupled to the first link may be located on the left of a region in which the third link of the left link module is coupled to the first link.

The second link and the third link of the right link module may be rotatably coupled to one of a top surface and a bottom surface of the first link, and the second link and the third link of the left link module may be rotatably coupled to the other one of the top surface and the bottom surface of the first link.

The wearable robot may further include a joint module rotatably coupled to a region, which wraps the shoulder of the user, of the fourth link and provided in contact with the arm of the user, wherein the joint module includes a shoulder link which is rotatably coupled to the fourth link and wraps the shoulder of the user, an upper link which is rotatably provided on the shoulder link, wraps an upper region of the arm of the user, and extends to the elbow of the user, and a lower link which is rotatably provided on the upper link and wraps a lower region of the arm of the user.

The joint module may further include an upper power assistant part which is provided in a region in which the shoulder link is coupled to the upper link and provides rotational force that assists rotation of the upper link with respect to the shoulder link, and a lower power assistant part which is provided in a region in which the upper link is coupled to the lower link and provides rotational force that assists rotation of the lower link with respect to the upper link.

The wearable robot may further include a shoulder wrapping unit, of which one side is coupled to the rear body unit and which extends from the one side via the back and shoulder of the user to wrap a front surface of the user.

The wearable robot may further include a waist wrapping unit, of which one side is coupled to the rear body unit and which wraps the waist of the user.

The other side of the shoulder wrapping unit may be coupled and fixed to the waist wrapping unit.

The first link may include a first-first link member and a first-second link member rotatably coupled to one side of the first-first link member, wherein each of the second link and the third link is rotatably coupled to one side of the first-second link member.

The first-second link member may be coupled to the first-first link member so as to be rotatable in an up-down direction, and each of the second link and the third link may be coupled to the first-second link member so as to be rotatable in a horizontal direction.

The first-second link member may be coupled to a front-rear direction side surface of the first-first link member, and each of the second link and the third link may be coupled to a top surface or a bottom surface of the first-second link member.

Two first-second link members may be provided in the first link, wherein a right end of the first-second link member, which is coupled to the second link and the third link provided in the right link module, of the two first-second link members is rotatably coupled to a right end of a rear surface of the first-first link member, and a left end of the first-second link member, which is coupled to the second link and the third link provided in the left link module, of the two first-second link members is rotatably coupled to a left end of a front surface of the first-first link member.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view illustrating a wearable robot and a user wearing the wearable robot according to an exemplary embodiment of the present disclosure.

FIG. 2 is an exploded perspective view illustrating the wearable robot according to an exemplary embodiment of the present disclosure.

FIG. 3 is a plan view illustrating a wearable robot and a user wearing the wearable robot according to an exemplary embodiment of the present disclosure.

FIG. 4 is a view schematically illustrating a coupled structure of first to fourth links of the wearable robot according to an exemplary embodiment of the present disclosure.

FIG. 5 is a plan view illustrating a shape of the wearable robot according to an exemplary embodiment of the present disclosure in the case where a user wearing the wearable robot performs the protraction motion.

FIG. 6 is a plan view illustrating a shape of the wearable robot according to an exemplary embodiment of the present disclosure in the case where the user wearing the wearable robot performs the retraction motion.

FIG. 7 is a side view illustrating a shape of the wearable robot according to an exemplary embodiment of the present disclosure in the case where the user wearing the wearable robot performs a motion of raising the arms in a state in which the shoulders are internally rotated.

FIG. 8 is a front view illustrating a shape of the wearable robot according to an exemplary embodiment of the present disclosure in the case where the user wearing the wearable robot performs a motion of raising the arms in a state in which the shoulders are externally rotated.

FIG. 9 is a side view illustrating a shape of the wearable robot according to an exemplary embodiment of the present disclosure in the case where the user wearing the wearable robot performs a motion of rotating a lower region of the arm about the elbow.

FIG. 10 is an exploded perspective view illustrating a wearable robot according to another exemplary embodiment of the present disclosure.

FIG. 11 is a rear view illustrating a shape of the wearable robot according to another exemplary embodiment of the present disclosure before a user wearing the wearable robot performs a motion of raising the shoulders.

FIG. 12 is a rear view illustrating a shape of the wearable robot according to another exemplary embodiment of the present disclosure in the case where the user wearing the wearable robot performs a motion of raising the shoulders.

### DETAILED DESCRIPTION OF ILLUSTRATIVE EMBODIMENTS

Hereinafter, a wearable robot according to embodiments of the present disclosure will be described with reference to the drawings.

### Wearable Robot

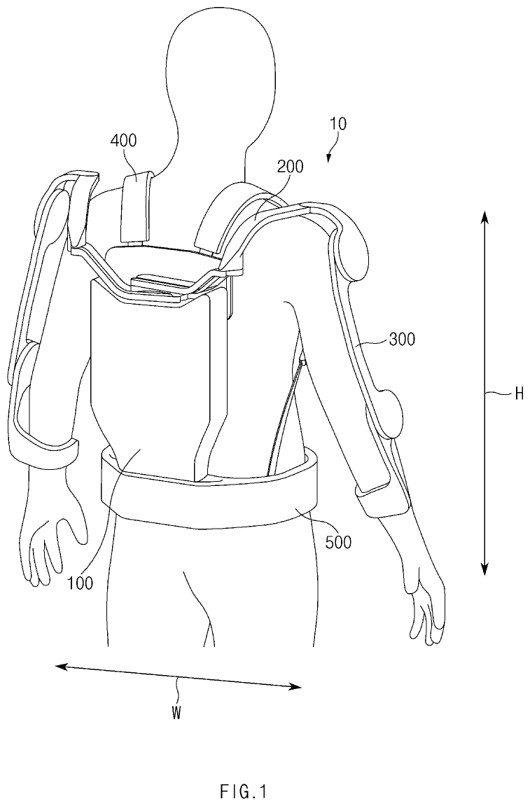

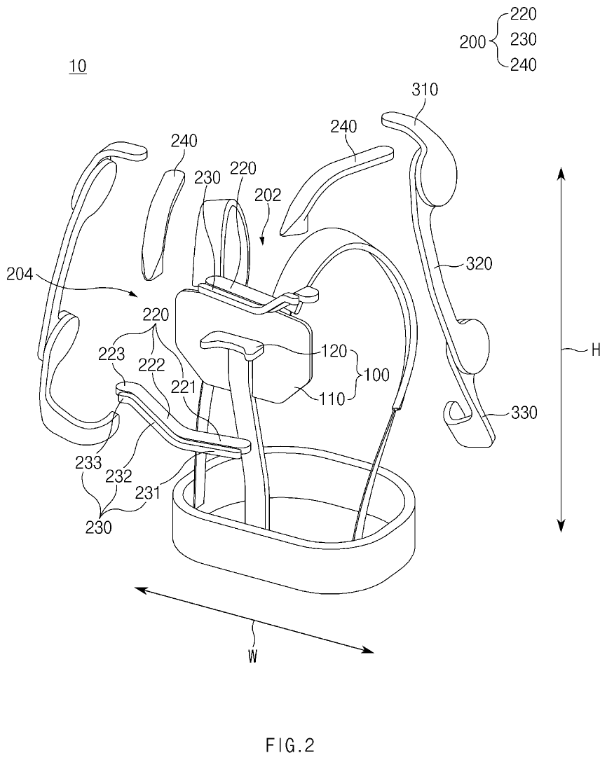

FIG. 1 is a perspective view illustrating a wearable robot and a user wearing the wearable robot according to an exemplary embodiment of the present disclosure, and FIG. 2 is an exploded perspective view illustrating the wearable robot according to an exemplary embodiment of the present disclosure.

A wearable robot 10 according to an exemplary embodiment of the present disclosure may be configured to be worn on the upper body of a user. More specifically, the wearable robot 10 is a device which not only may have a shape changing in response to the movement of the upper body of the user, but which may partially assist force required for the movement of joints. In particular, the wearable robot 10 according to an exemplary embodiment of the present disclosure may exhibit the movement similar to the rotational motion of the clavicle of the user around the sternoclavicular joint as described later, and thus the shape thereof may change in response to the protraction motion and retraction motion of the user. Thus, according to an exemplary embodiment of the present disclosure, wearing comfort of the wearable robot 10 may be maximized. Here, in the specification, a structure of the wearable robot 10, in a state in which the user wears the wearable robot 10 and puts the two arms down, is described.

Referring to FIGS. 1 and 2, the wearable robot 10 according to an exemplary embodiment of the present disclosure may be a wearable robot which is wearable by a user and may include a rear body unit 100 provided in close contact with the rear of the user and a link module 200, of which one side is coupled to the rear body unit 100 and the other side is positioned on the shoulder of the user.

The rear body unit 100 may include a body region 11o constituting a body of the rear body unit 100 and a first link 120 coupled to the body region 11o. Here, the link module 200 may be coupled to the first link 120. According to an exemplary embodiment of the present disclosure, the first link 120 may be constituted by a single member that is integrally formed.

More specifically, the link module 200 may include: a second link 220 rotatably coupled to one side of the first link 120, a third link 230 rotatably coupled to another side of the first link 120, and a fourth link 240, of which one side is rotatably coupled to the second link 220 and another side is rotatably coupled to the third link 230, and which extends to the shoulder of the user. According to an exemplary embodiment of the present disclosure, each of the second to fourth links 220, 230, and 240 may be constituted by a single member that is integrally formed.

More specifically, referring to FIG. 1, in a state in which the user wears the wearable robot 10, the second link 220 and the third link 230 may be provided on the first link 210 so as to be rotatable in the horizontal direction, and the fourth link 240 may be provided on the second link 220 and the third link 230 so as to be rotatable in the horizontal direction. As described later, the first to fourth links 210, 220, 230, and 240 are configured to change the shape of the wearable robot 10 in response to the protraction motion and retraction motion of a user according to the motion of the clavicle of the user.

Continuing to refer to FIGS. 1 and 2, a joint module 300 may be provided, which is rotatably coupled to a region, which wraps the shoulder of the user, of the fourth link 240 and provided in contact with the arm of the user. The joint module 300 may have a shape that changes in response to the movements of the shoulder joint and elbow joint of the user.

More specifically, the joint module 300 may include a shoulder link 310 which is rotatably coupled to the fourth link 240 and wraps the shoulder of the user, an upper link 320 which is rotatably provided on the shoulder link 310, wraps an upper region of the arm of the user, and extends to the elbow of the user, and a lower link 330 which is rotatably provided on the upper link 320 and wraps a lower region of the arm of the user. Here, the upper region and lower region of the arm of the user may be distinguished from each other by the elbow of the user. More specifically, the shoulder link 310 may be coupled to the fourth link 240 so as to be rotatable in the horizontal direction, the upper link 320 may be coupled to the shoulder link 310 so as to be rotatable in an up-down direction H, and the lower link 330 may be coupled to the upper link 320 so as to be rotatable in the up-down direction H.

Also, the joint module 300 may further include components that provide power for assisting with force required during the rotational motion of the joints of the user.

More specifically, the joint module 300 may further include an upper power assistant part which is provided in a region in which the shoulder link 310 is coupled to the upper link 320 and provides rotational force that assists rotation of the upper link 320 with respect to the shoulder link 310, and a lower power assistant part which is provided in a region in which the upper link 320 is coupled to the lower link 330 and provides rotational force that assists rotation of the lower link 330 with respect to the upper link 320. Each of the upper power assistant part and the lower power assistant part may include a motor member for providing power and a speed reduction member for reducing the rotational force of the motor member and transmitting the rotational force to the outside.

Continuing to refer to FIGS. 1 and 2, the wearable robot 10 may further include a shoulder wrapping unit 400, of which one side is coupled to the rear body unit 100 and which extends from the one side via the back and shoulder of the user to wrap a front surface of the user, and a waist wrapping unit 500, of which one side is coupled to the rear body unit 100 and which wraps the waist of the user. In one example, as illustrated in FIGS. 1 and 2, the other side of the shoulder wrapping unit 400 may be coupled and fixed to the waist wrapping unit 500.

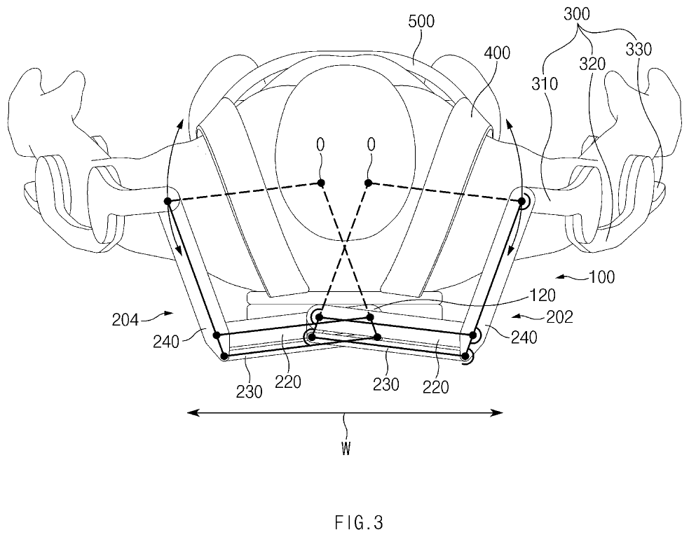

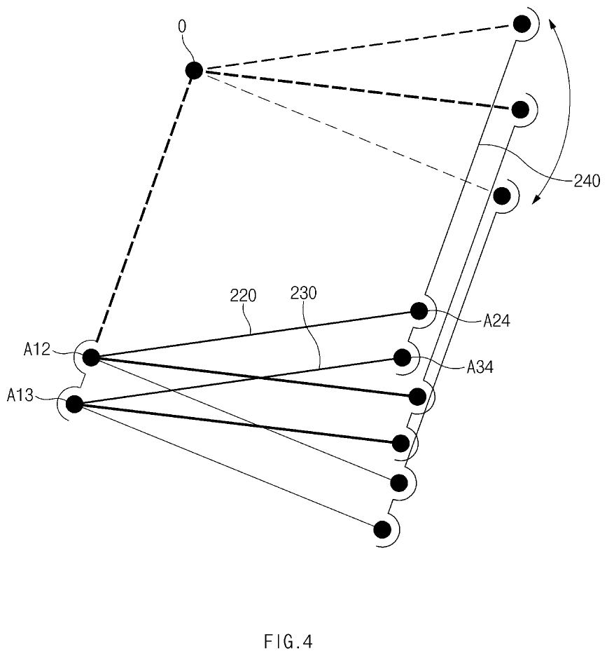

FIG. 3 is a plan view illustrating a wearable robot and a user wearing the wearable robot according to an exemplary embodiment of the present disclosure, and FIG. 4 is a view schematically illustrating a coupled structure of first to fourth links of the wearable robot according to an exemplary embodiment of the present disclosure.

As described above, according to an exemplary embodiment of the present disclosure, the wearable robot 10 may include first to fourth links 120, 220, 230, and 240. In particular, in the case where, as described above, the second link 220 and the third link 230 are rotatably coupled to the first link 120 while the fourth link 240 is rotatably coupled to the second link 220 and the third link 230, a region, which is provided in close contact with the shoulder of the user, of the fourth link 240 may rotate about a virtual rotation center O as illustrated in FIGS. 3 and 4. Thus, the shape of the wearable robot 10 may change in response to the protraction motion and retraction motion of the user according to the rotational motion of the clavicle in the sternoclavicular joint of the user, and thus the wearing comfort of the wearable robot 10 may be significantly enhanced.

Also, referring to FIGS. 1 to 4, a direction in which the second link 220 extends may be parallel to a direction in which the third link 230 extends, and the third link 230 may be located behind the second link 220.

Also, each of the second link 220 and the third link 230 may have a bent shape and may be divided into a plurality of regions with respect to the bent region.

More specifically, the second link 220 may include a second-first link region 221 of which one side is rotatably coupled to the first link 120 and which extends to the outside in a left-right direction W, a second-second link region 222 which extends from an outer end of the second-first link region 221 in the left-right direction W to the outside in the left-right direction W, and which extends to be inclined upward, and a second-third link region 223 which extends from an outer end of the second-second link region 222 in the left-right direction W to the outside in the left-right direction W, and which extends in parallel to the left-right direction W. Here, the fourth link 240 may be rotatably coupled to the second-third link region 223.

Also, the third link 230 may include a third-first link region 231, of which one side is rotatably coupled to the first link 120 and which extends to the outside in the left-right direction W, a third-second link region 232 which extends from an outer end of the third-first link region 231 in the left-right direction W to the outside in the left-right direction W, and which extends to be inclined upward, and a third-third link region 233 which extends from an outer end of the third-second link region 232 in the left-right direction W to the outside in the left-right direction W, and which extends in parallel to the left-right direction W. Here, the fourth link 240 may be rotatably coupled to the third-third link region 233.

More specifically, the length of the second link 220 in the left-right direction W may correspond to the length of the third link 230 in the left-right direction W, and the height of the second link 220 in the vertical direction H may correspond to the height of the third link 230 in the vertical direction H. In this case, a virtual line extending from a region A12 in which the first link 120 is coupled to the second link 220 and a region A13 in which the first link 120 is coupled to the third link 230 may be parallel to a virtual line extending from a region A24 in which the second link 220 is coupled to the fourth link 240 and a region A34 in which the third link 230 is coupled to the fourth link 240.

More specifically, as illustrated in FIG. 4, the virtual rotation center O, the region A12 in which the first link 120 is coupled to the second link 220, the region A24 in which the second link 220 is coupled to the fourth link 240, and the region, which is coupled to the shoulder link 310, of the fourth link 240 may have a parallelogram shape. Also, the virtual rotation center O, the region A13 in which the first link 120 is coupled to the third link 230, the region A34 in which the third link 230 is coupled to the fourth link 240, and the region, which is coupled to the shoulder link 310, of the fourth link 240 may also have a parallelogram shape. More preferably, the above-described two parallelograms are congruent to each other.

Also, as illustrated in FIGS. 1 and 2, the lengths of the second-first link region 221 and the third-first link region 231 in the left-right direction W may correspond to each other, the lengths and heights of the second-second link region 222 and the third-second link region 232 in the left-right direction W and the up-down direction H, respectively, may correspond to each other, and the lengths of the second-third link region 223 and the third-third link region 233 in the left-right direction W may correspond to each other.

Also, the link module 200 may be positioned on each of the right shoulder and left shoulder of the user. More specifically, the link module 200 may include a right link module 202, of which one side is coupled to the first link 120 and the other side is positioned on the right shoulder of the user, and a left link module 204, of which one side is coupled to the first link 120 and the other side is positioned on the left shoulder of the user. The contents which have been described about the features of the second to fourth links 220, 230, and 240 provided in the link module 200 may be applied, in the same manner, to each of the right link module 202 and the left link module 204, and thus the description of the links provided in each of the right link module 202 and the left link module 204 will be substituted by the earlier description.

Here, according to an exemplary embodiment of the present disclosure, a region in which the second link 220 of the right link module 202 is coupled to the first link 120 may be located on the left of a region in which the second link 220 of the left link module 204 is coupled to the first link 120, and a region in which the third link 230 of the right link module 202 is coupled to the first link 120 may be located on the left of a region in which the third link 230 of the left link module 204 is coupled to the first link 120. This can be understood as that, when viewed from above, the second link 220 of the right link module 202 and the second link 220 of the left link module 204 intersect with each other in a region coupled to the first link 120, and the third link 230 of the right link module 202 and the third link 230 of the left link module 204 intersect with each other in a region coupled to the first link 120.

In the case where the two second links 220 intersect with each other while the two third links 230 intersect with each other as described above, the virtual rotation center O with respect to the fourth link 240 of the right link module 202 and the virtual rotation center O with respect to the fourth link 240 of the left link module 204 may be provided adjacent to the sternoclavicular joint of the user. Thus, in the case where the protraction motion and retraction motion are generated as the clavicle rotates about the sternoclavicular joint of the user, the shape of the link module 200 may also be changed so as to fit the protraction motion and retraction motion of the user. Thus, an uncomfortable feeling of the user with respect to the change in shape of the link module 200 may be minimized, and wearing comfort may be significantly enhanced.

Also, according to an exemplary embodiment of the present disclosure, in order to prevent interference between the right link module 202 and the left link module 204, regions of the first link 120 to which the right link module 202 and the left link module 204 are coupled may be spaced apart from each other. More specifically, referring to FIG. 2, the second link 220 and the third link 230 of the right link module 202 may be rotatably coupled to one of a top surface and a bottom surface of the first link 120, and the second link 220 and the third link 230 of the left link module 204 may be rotatably coupled to the other one of the top surface and the bottom surface of the first link 120. In one example, FIG. 2 illustrates a state in which the second link 220 and the third link 230 of the right link module 202 are rotatably coupled to the top surface of the first link 120 while the second link 220 and the third link 230 of the left link module 204 are rotatably coupled to the bottom surface of the first link 120. Unlike the above, however, the second link 220 and the third link 230 of the right link module 202 may be rotatably coupled to the bottom surface of the first link 120 while the second link 220 and the third link 230 of the left link module 204 are rotatably coupled to the top surface of the first link 120.

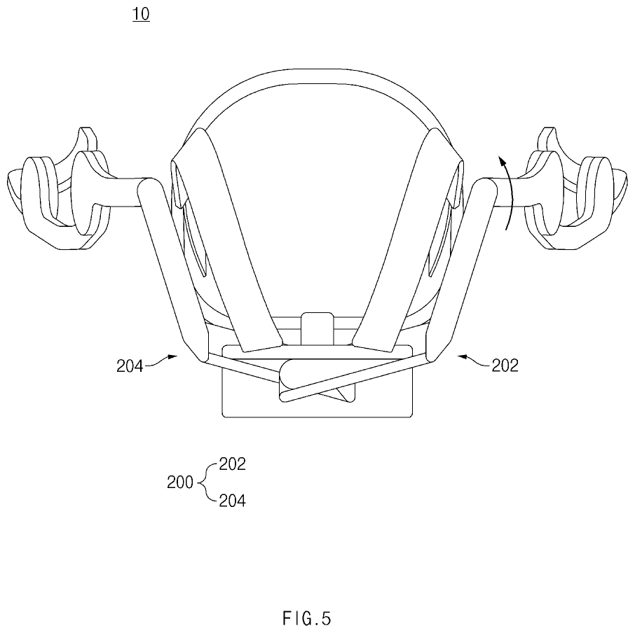

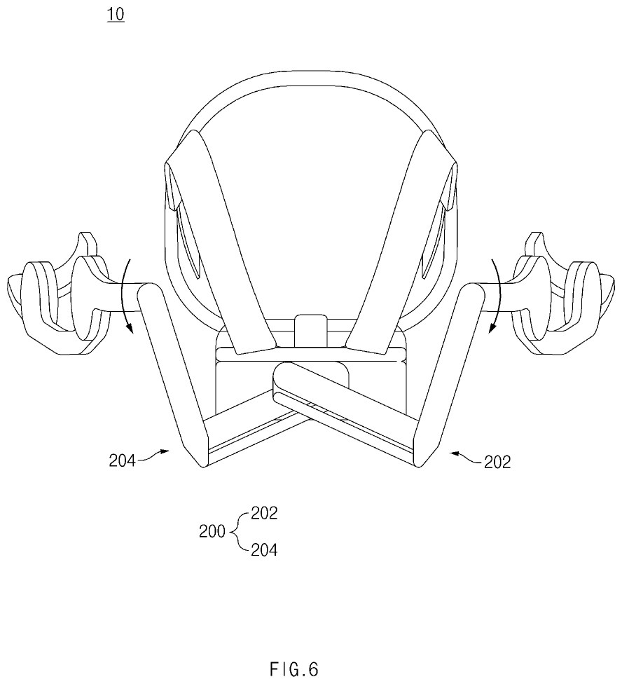

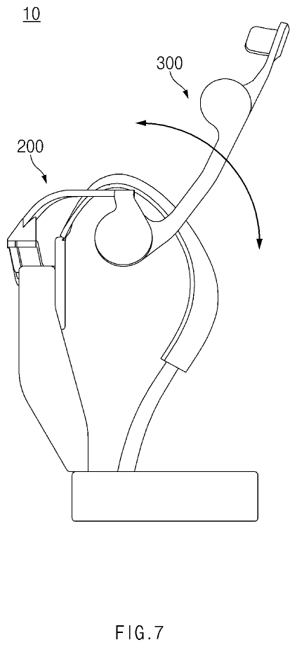

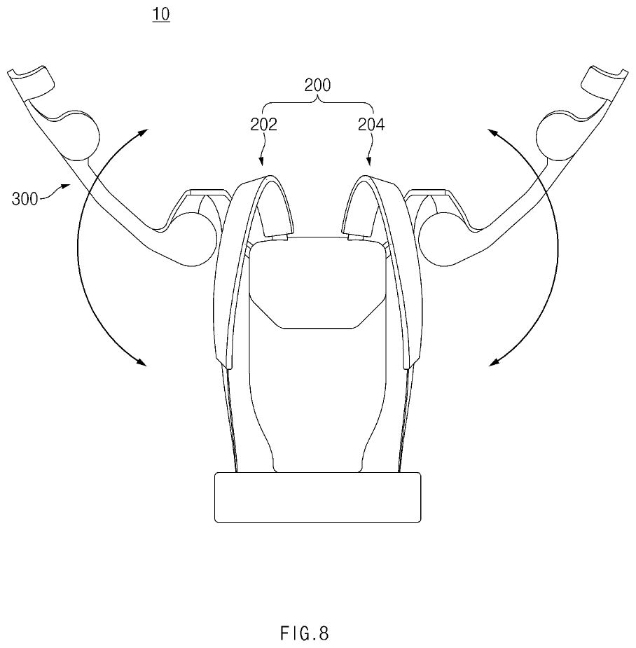

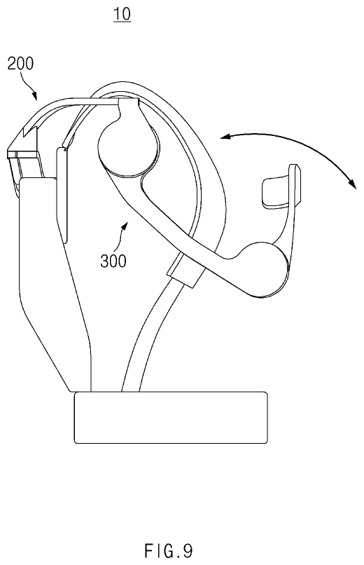

FIG. 5 is a plan view illustrating a shape of the wearable robot according to an exemplary embodiment of the present disclosure in the case where a user wearing the wearable robot performs the protraction motion, and FIG. 6 is a plan view illustrating a shape of the wearable robot according to an exemplary embodiment of the present disclosure in the case where the user wearing the wearable robot performs the retraction motion. FIG. 7 is a side view illustrating a shape of the wearable robot according to an exemplary embodiment of the present disclosure in the case where the user wearing the wearable robot performs a motion of raising the arms in a state in which the shoulders are internally rotated, and FIG. 8 is a front view illustrating a shape of the wearable robot according to an exemplary embodiment of the present disclosure in the case where the user wearing the wearable robot performs a motion of raising the arms in a state in which the shoulders are externally rotated. FIG. 9 is a side view illustrating a shape of the wearable robot according to an exemplary embodiment of the present disclosure in the case where the user wearing the wearable robot performs a motion of rotating a lower region of the arm about the elbow.

In the case where the user wearing the wearable robot 10 according to an exemplary embodiment of the present disclosure performs the protraction motion by rotating the clavicle forward about the sternoclavicular joint, the link module 200 changes as illustrated in FIG. 5. On the other hand, in the case where the user performs the retraction motion by rotating the clavicle rearward about the sternoclavicular joint, the link module 200 changes as illustrated in FIG. 6.

Meanwhile, according to an exemplary embodiment of the present disclosure as described above, the upper link 320 may be provided rotatable relative to the shoulder link 310 in the up-down direction H in a state in which the user wears the wearable robot 10. Here, in the case where the user performs a movement of raising the arms in a state in which the shoulders are internally rotated, the wearable robot 10 may achieve the movement as illustrated in FIG. 7. On the other hand, in the case where the user performs a movement of raising the arms in a state in which the shoulders are externally rotated, the wearable robot 10 may achieve the movement as illustrated in FIG. 8.

Also, in the case where the user rotates the lower region of the arm about the elbow, the wearable robot 10 may achieve the movement as illustrated in FIG. 9.

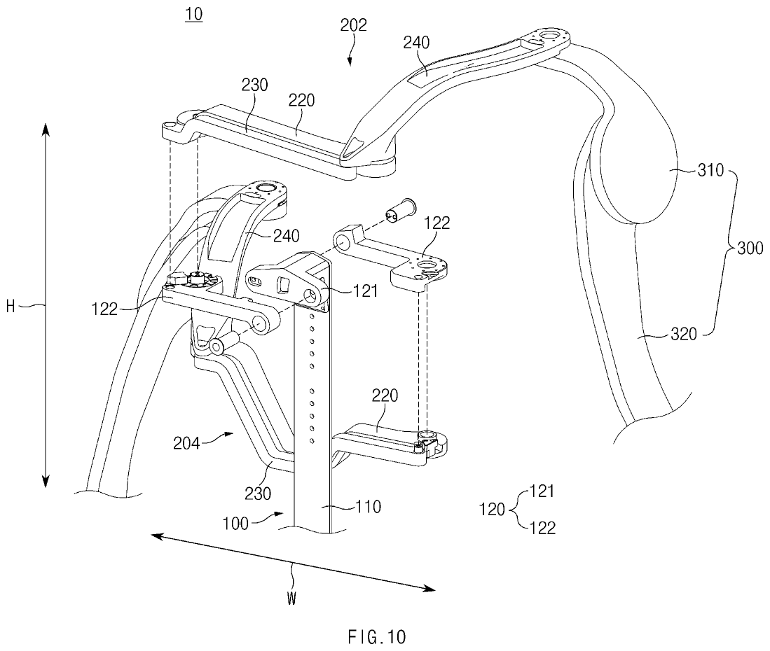

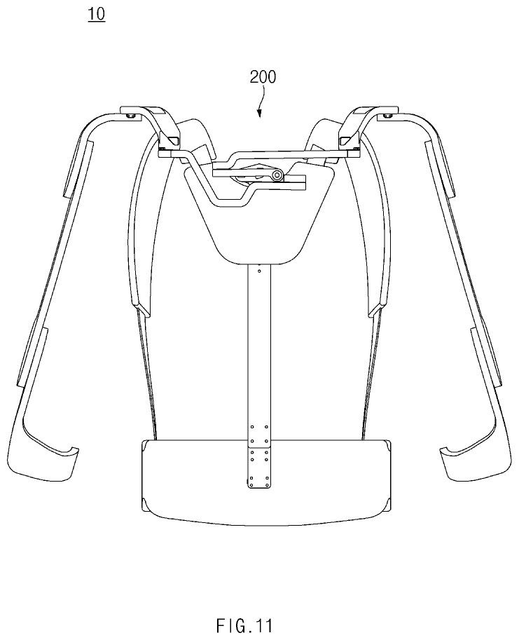

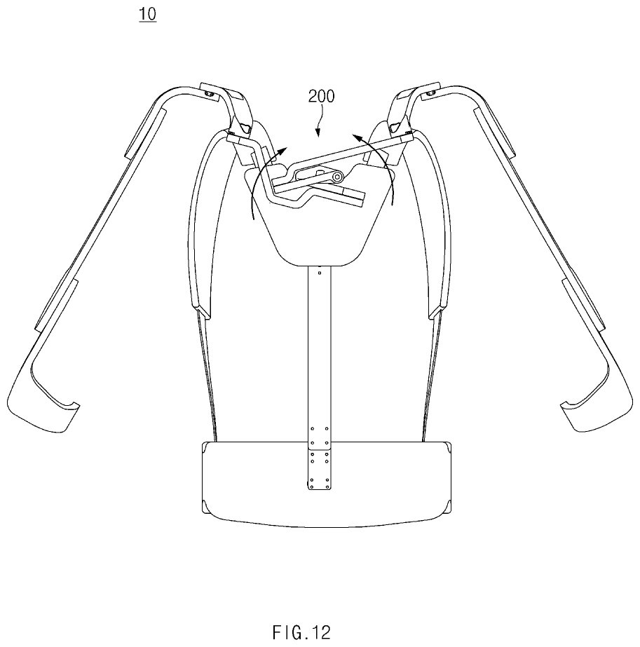

FIG. 10 is an exploded perspective view illustrating a wearable robot according to another exemplary embodiment of the present disclosure, and FIG. 11 is a rear view illustrating a shape of the wearable robot according to another exemplary embodiment of the present disclosure before a user wearing the wearable robot performs a motion of raising the shoulders. Also, FIG. 12 is a rear view illustrating a shape of the wearable robot according to another exemplary embodiment of the present disclosure in the case where the user wearing the wearable robot performs a motion of raising the shoulders.

Regarding a wearable robot 10 according to another exemplary embodiment of the present disclosure, there are differences as described below in terms of a first link 120, a second link 220, and a third link 230 provided in the wearable robot 10. Thus, except for contents describe below, contents of another exemplary embodiment of the present disclosure will be substituted by those which have been described in the exemplary embodiment of the present disclosure.

Referring to FIGS. 10 to 12, the first link 120 of the wearable robot 10 according to another exemplary embodiment of the present disclosure may have a shape in which a plurality of link members are assembled. That is, unlike the first link 120 made of the integrally formed single member according to the exemplary embodiment of the present disclosure, the first link 120 according to another exemplary embodiment of the present disclosure may have a structure in which a plurality of different link members are coupled to each other.

That is, as illustrated in FIGS. 10 to 12, the first link 120 may include a first-first link member 121 coupled to one side of a body region 11o, and a first-second link member 122 rotatably coupled to one side of the first-first link member 121. Also, each of the second link 220 and the third link 230 may be rotatably coupled to one side of the first-second link member 122.

More specifically, the first-second link member 122 may be coupled to the first-first link member 121 so as to be rotatable in an up-down direction H, and each of the second link 220 and the third link 230 may be coupled to the first-second link member 122 so as to be rotatable in a horizontal direction. FIGS. 10 to 12 illustrate as one example a state in which the first-second link member 122 is coupled to a front-rear direction side surface of the first-first link member 121 and a state in which each of the second link 220 and the third link 230 is coupled to a top surface or a bottom surface of the first-second link member 122.

More preferably, two first-second link members 122 may be provided. Each of the second link 220 and the third link 230 provided in a right link module 202 may be rotatably coupled to one of the two first-second link members 122, and each of the second link 220 and the third link 230 provided in a left link module 204 may be rotatably coupled to the other one of the two first-second link members 122. FIGS. 10 to 12 illustrate as one example a state in which a right end of the first-second link member 122, which is coupled to the second link 220 and the third link 230 provided in the right link module 202, of the two first-second link members 122 is rotatably coupled to a right end of a rear surface of the first-first link member 121, and a state in which a left end of the first-second link member 122, which is coupled to the second link 220 and the third link 230 provided in the left link module 204, of the two first-second link members 122 is rotatably coupled to a left end of a front surface of the first-first link member 121.

Also, referring to FIGS. 10 to 12, in the wearable robot 10 according to another exemplary embodiment of the present disclosure, a virtual line extending from a central axis about which a shoulder link 310 rotates relative to a fourth link 240 may intersect with a virtual line extending from a central axis about which an upper link 320 rotates relative to the shoulder link 310. This may be to ensure that, according to movement of the user wearing the wearable robot 10, the shape of the wearable robot 10 is also allowed to change in accordance with the movement, and thus wearing comfort is maximized.

According to another exemplary embodiment of the present disclosure, before the user wearing the wearable robot 10 performs motion of raising the shoulders, the first-second link member 122 maintains a state as illustrated in FIG. 11 in which no rotational motion is performed with respect to the first-first link member 121.

Then, when the user performs the motion of raising the shoulders, the first-second link member 122 is inclined while rotating with respect to the first-first link member 121 in the up-down direction H as illustrated in FIG. 12. Accordingly, the second link 220 and the third link 230 are also inclined, and the shape changes in accordance with the shoulder motion of the user. More specifically, in the case where the user performs the motion of raising the shoulders, the first-second link member 122, which is coupled to the right link module 202, of the two first-second link members 122 rotates counterclockwise with respect to the first-first link member 121, and the second link 220 and the third link 230 provided in the right link module 202 are inclined to the left. On the other hand, the first-second link member 122, which is coupled to the left link module 204, of the two first-second link members 122 rotates clockwise with respect to the first-first link member 121, and the second link 220 and the third link 230 provided in the left link module 204 are inclined to the right.

According to embodiments of the present disclosure, the Exo-robot may be provided which has the structure in which the shape thereof may change in response to the protraction motion and retraction motion of a person.

Although the present disclosure has been described with specific exemplary embodiments and drawings, the present disclosure is not limited thereto, and it is obvious that various changes and modifications may be made by a person skilled in the art to which the present disclosure pertains within the technical idea of the present disclosure and equivalent scope of the appended claims.

What is claimed is:

1. A wearable robot comprising:
a rear body unit configured to be provided in close contact with a rear side of a user, the rear body unit comprising a first link; and
a link module having a first side coupled to the rear body unit and a second side configured to be positioned on a shoulder of the user, the link module comprising:
a second link rotatably coupled to a first side of the first link;
a third link rotatably coupled to a second side of the first link; and
a fourth link having a first side rotatably coupled to the second link and a second side rotatably coupled to the third link, the fourth link being configured to extend to the shoulder of the user.

2. The wearable robot of claim 1, wherein the third link is located behind the second link.

3. The wearable robot of claim 1, wherein a direction in which the second link extends is parallel to a direction in which the third link extends.

4. The wearable robot of claim 3, wherein the second link comprises:
a second-first link region having a first side rotatably coupled to the first link and extending to outside in a left-right direction; and
a second-second link region extending from a left-right direction outer end of the second-first link region to the outside in the left-right direction, wherein the second-second link region extends to be inclined upward.

5. The wearable robot of claim 4, wherein:
the second link further comprises a second-third link region extending from a left-right direction outer end of the second-second link region to the outside in the left-right direction; and
the fourth link is rotatably coupled to the second-third link region.

6. The wearable robot of claim 3, wherein the third link comprises:
a third-first link region having a first side rotatably coupled to the first link and extending to the outside in a left-right direction; and
a third-second link region extending from a left-right direction outer end of the third-first link region to the outside in the left-right direction, wherein the third-second link region extends to be inclined upward.

7. The wearable robot of claim 6, wherein:
the third link further comprises a third-third link region extending from a left-right direction outer end of the third-second link region to the outside in the left-right direction; and
the fourth link is rotatably coupled to the third-third link region.

8. The wearable robot of claim 1, wherein a first virtual line extending from a first region in which the first link is coupled to the second link and a second region in which the first link is coupled to the third link is parallel to a second virtual line extending from a third region in which the second link is coupled to the fourth link and a fourth region in which the third link is coupled to the fourth link.

9. The wearable robot of claim 1, further comprising a shoulder wrapping unit having a first side coupled to the rear body unit and configured to extend from the first side via a back and the shoulder of the user to wrap a front surface of the user.

10. The wearable robot of claim 9, further comprising a waist wrapping unit having a first side coupled to the rear body unit and configured to wrap a waist of the user.

11. The wearable robot of claim 10, wherein a second side of the shoulder wrapping unit is coupled and fixed to the waist wrapping unit.

12. A wearable robot comprising:
a rear body unit configured to be provided in close contact with a rear side of a user, the rear body unit comprising a first link; and
a link module having a first side coupled to the rear body unit and a second side configured to be positioned on a shoulder of the user, the link module comprising:
a second link rotatably coupled to a first side of the first link;
a third link rotatably coupled to a second side of the first link; and
a fourth link having a first side rotatably coupled to the second link and a second side rotatably coupled to the third link, the fourth link being configured to extend to the shoulder of the user;
a right link module having a first side coupled to the first link and a second side configured to be positioned on a right shoulder of the user; and
a left link module having a first side coupled to the first link and a second side configured to be positioned on a left shoulder of the user; and
wherein a first region in which the second link of the right link module is coupled to the first link is located on the left of a second region in which the second link of the left link module is coupled to the first link.

13. The wearable robot of claim 12, wherein a third region in which the third link of the right link module is coupled to the first link is located on the left of a fourth region in which the third link of the left link module is coupled to the first link.

14. The wearable robot of claim 12, wherein:
the second link and the third link of the right link module are rotatably coupled to a top surface or a bottom surface of the first link; and
the second link and the third link of the left link module are rotatably coupled to the other of the top surface or the bottom surface of the first link.

15. The wearable robot of claim 12, wherein the first link comprises:
a first-first link member; and
a first-second link member rotatably coupled to a first side of the first-first link member, wherein each of the second link and the third link is rotatably coupled to a first side of the first-second link member.

16. The wearable robot of claim 15, wherein:
the first-second link member is coupled to the first-first link member so as to be rotatable in an up-down direction; and
each of the second link and the third link is coupled to the first-second link member so as to be rotatable in a horizontal direction.

17. The wearable robot of claim 16, wherein:
the first-second link member is coupled to a front-rear direction side surface of the first-first link member; and
each of the second link and the third link is coupled to a top surface or a bottom surface of the first-second link member.

18. The wearable robot of claim 17, wherein:
two first-second link members are provided in the first link;
a right end of the first-second link member, which is coupled to the second link and the third link provided in the right link module, of the two first-second link members is rotatably coupled to a right end of a rear surface of the first-first link member; and
a left end of the first-second link member, which is coupled to the second link and the third link provided in the left link module, of the two first-second link members is rotatably coupled to a left end of a front surface of the first-first link member.

19. A wearable robot comprising:
a rear body unit configured to be provided in close contact with a rear side of a user, the rear body unit comprising a first link; and
a link module having a first side coupled to the rear body unit and a second side configured to be positioned on a shoulder of the user, the link module comprising:
a second link rotatably coupled to a first side of the first link;
a third link rotatably coupled to a second side of the first link; and
a fourth link having a first side rotatably coupled to the second link and a second side rotatably coupled to the third link, the fourth link being configured to extend to the shoulder of the user; and
a joint module rotatably coupled to a first region of the fourth link, the first region being configured to wrap the shoulder of the user, and configured to be in contact with an arm of the user, the joint module comprising:
a shoulder link rotatably coupled to the fourth link and configured to wrap the shoulder of the user;
an upper link rotatably provided on the shoulder link and configured to wrap an upper region of the arm of the user and extend to an elbow of the user; and
a lower link rotatably provided on the upper link and configured to wrap a lower region of the arm of the user.

20. The wearable robot of claim 19, wherein the joint module further comprises:
an upper power assistant part provided in a second region in which the shoulder link is coupled to the upper link and configured to provide rotational force that assists rotation of the upper link with respect to the shoulder link; and
a lower power assistant part provided in a third region in which the upper link is coupled to the lower link and configured to provide rotational force that assists rotation of the lower link with respect to the upper link.
